(19) United States
(12) Patent Application Publication
(10) Pub. No.: US 2021/0079146 A1
(43) Pub. Date: Mar. 18, 2021

(54) POLYOLEFIN DERIVATIVE AND COMPOSITE MATERIAL

(71) Applicant: Daxin Materials Corporation, Taichung City (TW)

(72) Inventors: Ming-Tsung Tsai, Taichung City (TW); Cheng-Hung Lee, Taichung City (TW); Wei-Yao Lai, Taichung City (TW)

(73) Assignee: Daxin Materials Corporation, Taichung City (TW)

(21) Appl. No.: 16/828,960

(22) Filed: Mar. 25, 2020

(30) Foreign Application Priority Data
Sep. 17, 2019 (TW) 108133435

(51) Int. Cl. C08F 255/02; C08K 9/04; C08K 11/00; C08K 3/36; C08K 3/22; C08K 3/26; C08K 3/34; C08L 51/06

(52) U.S. Cl. CPC C08F 255/02; C08K 9/04; C08K 11/00; C08K 3/36; C08K 2003/265; C08K 3/26; C08K 3/34; C08L 51/06; C08K 3/22

(57) ABSTRACT

A polyolefin derivative and a composite material are provided. The polyolefin derivative is formed by reacting a modified polyolefin and an amine compound, wherein the modified polyolefin is formed by grafting a maleic anhydride onto a polyolefin. The amine compound includes a polyether amine and an alkylamine. Based on 100 parts by mole of the maleic anhydride group in the modified polyolefin, a reacting amount of the alkylamine is 1 part by mole to 40 parts by mole.

### CROSS-REFERENCE TO RELATED APPLICATION

This application claims the priority benefit of Taiwan application serial no. 108133435, filed on Sep. 17, 2019. The entirety of the above-mentioned patent application is hereby incorporated by reference herein and made a part of this specification.

### BACKGROUND OF THE INVENTION

### Field of the Invention

The invention relates to a polymer and a composite material, and more particularly to a polyolefin derivative and a composite material.

### Description of Related Art

Polyolefin such as polyethylene and polypropylene is a common general-purpose plastic, and has the advantages of low density, easy processing, low cost, and good comprehensive performance, and is widely used in various fields. However, polyolefin is a polymer compound formed by the addition polymerization of an olefin molecule, and is structurally mostly a hydrophobic functional group (non-polar functional group), and thus polyolefin is a non-polar polymer. Further, since the molecular chain of polyolefin does not contain a polar group, the compatibility, adhesion, dyeability, moisture retention, and antistatic properties thereof are poor. Therefore, how to modify polyolefin to increase the applicability thereof is an issue that those skilled in the art are currently trying to solve.

### SUMMARY OF THE INVENTION

The invention provides a polyolefin derivative and a composite material containing the same, wherein the polyolefin derivative has an amphiphilic structure (i.e., has both a non-polar (hydrophobic) functional group and a polar (hydrophilic) functional group) and therefore has good applicability. Further, the polyolefin derivative of the invention is obtained by reacting a polyolefin grafted with maleic anhydride and an amine compound containing a polyether amine and a specific ratio of an alkylamine, and has good heat resistance and dispersibility. Moreover, the composite material of the invention has good dispersibility for a non-polar substance.

The invention provides a polyolefin derivative formed by reacting a modified polyolefin and an amine compound, wherein the modified polyolefin is formed by grafting a maleic anhydride onto a polyolefin. The amine compound includes a polyether amine and an alkylamine. Based on 100 parts by mole of the maleic anhydride group in the modified polyolefin, a reacting amount of the alkylamine is 1 part by mole to 40 parts by mole.

In an embodiment of the invention, based on 100 parts by mole of the maleic anhydride group in the modified polyolefin, a reacting amount of the polyether amine is 60 parts by mole to 99 parts by mole.

In an embodiment of the invention, a weight-average molecular weight of the polyether amine is 1500 to 5000.

In an embodiment of the invention, the polyether amine includes at least one of a compound represented by formula (1) and a compound represented by formula (2).

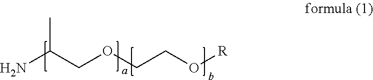

In formula (1), R is a C₁ to C₁₀ alkyl group, a is an integer of 0 to 85, b is an integer of 0 to 112, and a sum of a and b is an integer of 22 to 112.

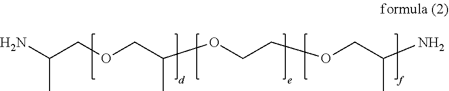

In formula (2), d and f are respectively an integer of 1 or more, a sum of d and f is an integer of 2 to 85, and e is an integer of 0 to 112.

In an embodiment of the invention, the alkylamine includes at least one of a compound represented by formula (3) and a compound represented by formula (4).

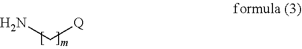

In formula (3), m is an integer of 2 to 5, and Q is *—OR¹, *-NR²R³

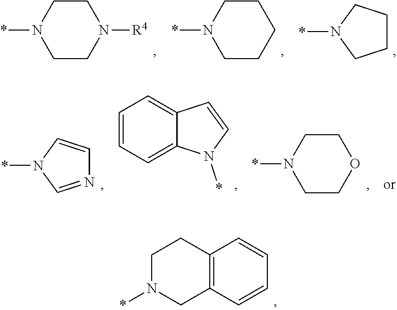

wherein R¹, R², R³, and R⁴ are respectively hydrogen or a C₁ to C₆ alkyl group, R² and R³ are not hydrogen at the same time, and * represents a bonding position.

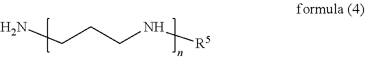

In formula (4), n is an integer of 0 to 3, and R⁵ is a C₈ to C₂₂ alkyl group.

The invention further provides a polyolefin derivative including a structural unit represented by formula (5) and a structural unit represented by formula (6).

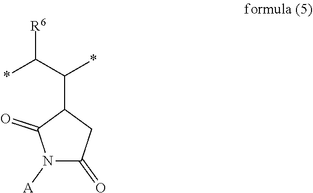

In formula (5), R⁶ is a hydrogen atom or an alkyl group, A is a monovalent organic group having an oxyalkylene group, and * represents a bonding position.

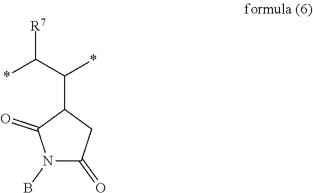

In formula (6), R⁷ is a hydrogen atom or an alkyl group, B is a monovalent organic group, the monovalent organic group is a monovalent organic group having an alkoxy group, an alkyl group, or a monovalent organic group having a nitrogen atom, and * represents a bonding position.

In an embodiment of the invention, a total of the structural unit represented by formula (5) and the structural unit represented by formula (6) is 100 parts by mole, and a quantity of the structural unit represented by formula (6) is 1 part by mole to 40 parts by mole.

In an embodiment of the invention, a total of the structural unit represented by formula (5) and the structural unit represented by formula (6) is 100 parts by mole, and a quantity of the structural unit represented by formula (5) is 60 parts by mole to 99 parts by mole.

In an embodiment of the invention, a molecular weight of the monovalent organic group having the oxyalkylene group as A is 1480 to 4985.

In an embodiment of the invention, the monovalent organic group having the oxyalkylene group as A is a group represented by formula (5-1) or a group represented by formula (5-2).

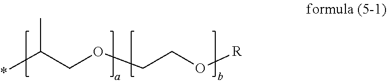

In formula (5-1), R is a C₁ to C₁₀ alkyl group, a is an integer of 0 to 85, b is an integer of 0 to 112, a sum of a and b is an integer of 22 to 112, and * represents a bonding position.

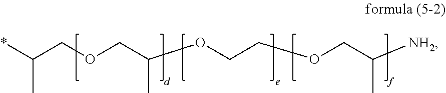

In formula (5-2), d and f are respectively an integer of 1 or more, a sum of d and f is an integer of 2 to 85, e is an integer of 0 to 112, and * represents a bonding position.

In an embodiment of the invention, the monovalent organic group as B is a group represented by formula (6-1) or a group represented by formula (6-2).

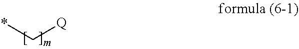

In formula (6-1), m is an integer of 2 to 5, and Q is *—OR¹, *-NR²R³

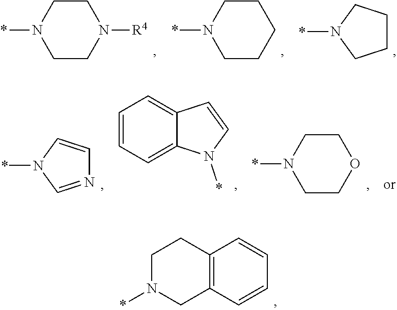

wherein R¹, R², R³, and R⁴ are respectively hydrogen or a C₁ to C₆ alkyl group, R² and R³ are not hydrogen at the same time, and * represents a bonding position.

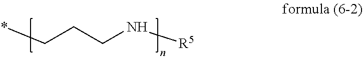

In formula (6-2), n is an integer of 0 to 3, and R⁵ is a C₈ to C₂₂ alkyl group.

In an embodiment of the invention, the monovalent organic group having the alkoxy group as A is a group represented by formula (5-1), and the monovalent organic group as B is a group represented by formula (6-1).

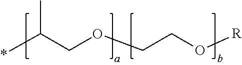

In formula (5-1), R is a C₁ to C₁₀ alkyl group, a is an integer of 0 to 85, b is an integer of 0 to 112, a sum of a and b is an integer of 22 to 112, and * represents a bonding position.

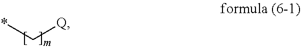

In formula (6-1), m is an integer of 2 to 5, and Q is *—OR¹, *—NR²R³

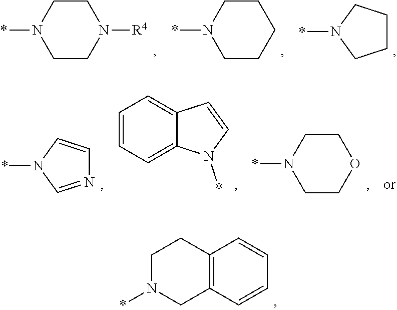

wherein R¹, R², R³, and R⁴ are respectively hydrogen or a C₁ to C₆ alkyl group, R² and R³ are not hydrogen at the same time, and * represents a bonding position.

In an embodiment of the invention, the polyolefin derivative is a derivative derived from a polyolefin, and the polyolefin includes polyethylene, polypropylene, or a combination thereof.

The invention also provides a composite material including the above polyolefin derivative and a filler.

In an embodiment of the invention, based on an amount of 100 parts by weight of the filler, an amount of the polyolefin derivative is 10 parts by weight to 200 parts by weight.

In an embodiment of the invention, the filler includes a ceramic, a silicate layered material, aluminum oxide, silicon dioxide, calcium carbonate, wollastonite, barium sulfate, zinc sulfide, lithopone, cellulose, or a combination thereof.

Based on the above, the invention provides a polyolefin derivative having an amphiphilic structure and a composite material containing the polyolefin derivative, and thus good applicability may be achieved. In addition, in the polyolefin derivative of the invention, a polyolefin grafted with maleic anhydride is reacted with a polyether amine and an alkylamine to prepare a polyolefin derivative for which a main chain is a polyolefin and a side chain contains a functional group introduced by the polyether amine and the alkylamine. Therefore, the polyolefin derivative not only has an amphiphilic structure, but also allows the maleic anhydride group and the ring-opened carboxylic acid to be completely reacted, thus contributing to the improvement of the heat resistance of the polyolefin derivative. Further, the polyolefin derivative of the invention is obtained by reacting a polyolefin grafted with maleic anhydride and an amine compound containing a polyether amine and a specific ratio of an alkylamine, such that the polyolefin derivative has good heat resistance and dispersibility. Moreover, the composite material of the invention includes the polyolefin derivative and a filler, and therefore good dispersibility is achieved in a non-polar substance, such that uniform mixing with a polyolefin may be achieved to improve the mechanical properties of the polyolefin via a good dispersion effect of the filler.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is an IR spectrum of a polyolefin derivative of Example 8.

FIG. 2 is an IR spectrum of a polyolefin derivative of Comparative example 8.

### DESCRIPTION OF THE EMBODIMENTS

### <Polyolefin Derivative>

A polyolefin derivative according to the present embodiment is a derivative derived from a polyolefin. The polyolefin derivative is formed by reacting a modified polyolefin (a) and an amine compound (b), wherein the modified polyolefin (a) is formed by grafting a maleic anhydride onto a polyolefin.

Thereby, in the present embodiment, by providing the amine compound (b) with a hydrophobic polyolefin as a main chain and a polar (hydrophilic) functional group, the polyolefin has an amphiphilic structure, so the polyolefin derivative has good applicability (for example: antistatic, moisturizing and water guiding, etc.) and good heat resistance.

Next, the modified polyolefin (a) and the amine compound (b) are described in detail.

### Modified Polyolefin (a)

The modified polyolefin (a) is formed by grafting a maleic anhydride radical onto a polyolefin.

The polyolefin includes polyethylene, polypropylene, or a combination thereof. Further, the monomer of the polyolefin may further include other olefins other than ethylene, propylene, or the like without affecting the efficacy of the invention.

Specific examples of commercial products of the modified polyolefin (a) include UMEX 1010 (manufactured by Sanyo Chemical Industries, Ltd., weight-average molecular weight: 30,000, amount of maleic anhydride group: 4.5 wt %), Epolene E-43, MPP-9100 (manufactured by American Eastman Chemical Co., Ltd., weight-average molecular weight: 9100, amount of maleic anhydride group: 3.9 wt %), or a combination thereof.

### Amine Compound (b)

The amine compound (b) includes a polyether amine (b1) and an alkylamine (b2).

The polyether amine (b1) and the alkylamine (b2) may be bonded to the modified polyolefin (a) by a hydrolysis condensation reaction and a dehydration cyclization reaction with a maleic anhydride group on the modified polyolefin (a), respectively to form a polyolefin derivative.

In the present embodiment, the polyether amine (b1) is first completely reacted with a maleic anhydride group on the modified polyolefin (a), and then the remaining maleic anhydride groups on the modified polyolefin (a) are completely reacted with an excess of the alkylamine (b2), and the cyclization reaction of imide is catalyzed. In the present embodiment, the “reacting amount” is an amount in which the polyether amine (b1) and the alkylamine (b2) are actually reacted with the maleic anhydride group on the polyolefin (a). In particular, since the polyether amine (b1) and the maleic anhydride group on the modified polyolefin (a) are controlled to be completely reacted, the amount of the polyether amine (b1) in the reaction solution is substantially the same as the reacting amount thereof. Further, since the alkylamine (b2) is an excess reagent relative to the modified polyolefin (a) and the alkylamine (b2) may be completely reacted with the remaining maleic anhydride groups on the modified polyolefin (a), the amount of the alkylamine (b2) in the reaction solution is not the same as the reacting amount thereof.

It is noteworthy that in the case where only the polyether amine (b1) is used alone to react with the modified polyolefin (a), although the synthesized polyolefin derivative has both a hydrophobic functional group and a hydrophilic functional group, the reaction of the modified polyolefin and the polyether amine is incomplete. In addition, even if the polyether amine is controlled to be excessively equivalent, the reaction of the modified polyolefin and the polyether amine is still incomplete, and thus the synthesized polyolefin derivative may not have satisfactory heat resistance. In this regard, in the present embodiment, an alkylamine is further introduced into the reaction of the modified polyolefin and the polyether amine, so that the maleic anhydride group, the polyether amine, and the alkylamine on the modified polyolefin are more completely reacted, and the synthesis reaction is efficient. As a result, the polyolefin derivative of the present embodiment is obtained.

### Polyether Amine (b1)

The polyether amine (b1) is a compound having a polyether polyol as a main skeleton and for which at least one end of the polyether polyol is an amine group. Furthermore, the polyether amine (b1) includes at least one of a compound represented by formula (1) and a compound represented by formula (2), and the compound represented by formula (1) is preferred.

The compound represented by formula (1) is a polymer in which the two ends of the polyether polyol are respectively an amine group and an alkoxy group.

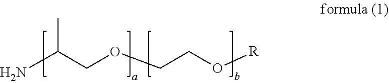

In formula (1), R is a C₁ to C₁₀ alkyl group, preferably a methyl group; a is an integer of 0 to 85; b is an integer of 0 to 112, and a sum of a and b is an integer of 22 to 112.

Specific examples of the compound represented by formula (1) include Jeffamine M2070 (manufactured by Huntsman Chemical Co., weight-average molecular weight: 2000, in formula (1), a: 10, b: 31), Jeffamine M3085 (manufactured by Huntsman Chemical Co., Ltd., weight-average molecular weight: 3000, in formula (1), a: 8, b: 58), or a combination thereof.

The compound represented by formula (2) is a polymer for which the two ends of the polyether polyol are amine groups.

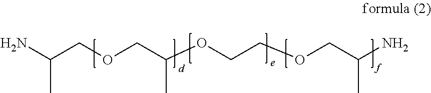

In formula (2), d and f are respectively an integer of 1 or more, a sum of d and f is an integer of 2 to 85, and e is an integer of 0 to 112.

Specific examples of the compound represented by formula (2) include Jeffamine ED2001, ED6000, D2000 (manufactured by Huntsman Chemical Co., Ltd.), or a combination thereof.

The polyether amine (b1) may have a weight-average molecular weight of 1500 to 5000, preferably 2000 to 4000.

Based on 100 parts by mole of the maleic anhydride group in the modified polyolefin, a reacting amount of the polyether amine (b1) is 60 parts by mole to 99 parts by mole. When the reacting amount of the polyether amine (b1) is within the above range, the polyolefin derivative has good heat resistance and dispersibility, and thus has good applicability. When the reacting amount of the polyether amine (b1) is less than 60 parts by mole, the dispersibility of the polyolefin derivative is poor. When the reacting amount of the polyether amine (b1) is greater than 99 parts by mole, the heat resistance of the polyolefin derivative is poor, and the synthesis reaction of the modified polyolefin and the polyether amine is inefficient.

### Alkylamine (b2)

The alkylamine (b2) is a compound having a hydrocarbon as a main skeleton, and at least one end of the hydrocarbon is an amine compound. Furthermore, the alkylamine (b2) includes at least one of a compound represented by formula (3) and a compound represented by formula (4), and preferably includes the compound represented by formula (3). When the alkylamine (b2) includes the compound represented by formula (3), the polyolefin derivative has better dispersibility.

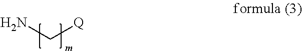

in formula (3),
m is an integer of 2 to 5, preferably an integer of 2 to 3;
Q is *—OR¹, *—NR²R³,

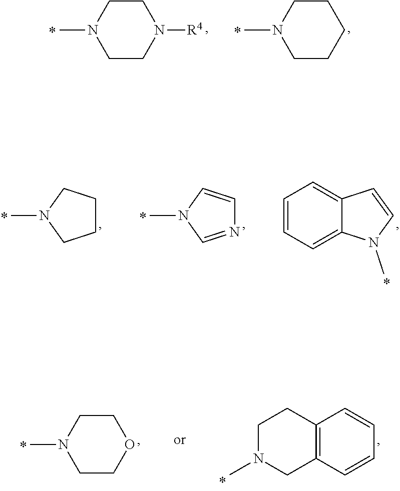

preferably *—NR²R³ or

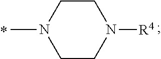

R¹, R², R³, and R⁴ are respectively hydrogen or a C₁ to C₆ alkyl group, R² and R³ are not hydrogen at the same time, and * represents a bonding position.

In an embodiment, when Q is *—NR²R³, R² and R³ are preferably a methyl group or an ethyl group, respectively.

In an embodiment, when Q is

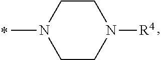

R⁴ is preferably hydrogen.

Specific examples of the compound represented by formula (3) include 3-diethylaminopropylamine (DEX), 3-dimethylaminopropylamine (DMX), aminoethylpiperazine (N-AEP), or a combination thereof.

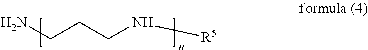

in formula (4),
n is an integer of 0 to 3, preferably 0 or 1;
R⁵ is a C₈ to C₂₂ alkyl group, preferably a C₁₈ alkyl group.

In an embodiment, when n is 0, R⁵ is preferably a C₁₈ alkyl group.

In an embodiment, when n is 1, R⁵ is preferably a C₁₈ alkyl group.

Specific examples of the compound represented by formula (4) include N-octadecylpropane-1,3-diamine (product name “Duomeen O”, manufactured by Akzo Nobel Co., Ltd.), octadecylamine, or a combination thereof.

Based on 100 parts by mole of the maleic anhydride group in the modified polyolefin, a reacting amount of the alkylamine is 1 part by mole to 40 parts by mole. When the reacting amount of the alkylamine is within the above range, the polyolefin derivative has good heat resistance and dispersibility, and thus has good applicability. When the reacting amount of the alkylamine is greater than 40 parts by mole, the dispersibility of the polyolefin derivative is poor. When the reacting amount of the alkylamine is less than 1 part by mole, the heat resistance of the polyolefin derivative is poor, and the synthesis reaction of the modified polyolefin and the polyether amine is inefficient.

### <Preparation of Polyolefin Derivative>

First, a maleic anhydride is first grafted onto a polyolefin to form the modified polyolefin (a). The method of grafting the maleic anhydride onto the polyolefin is not particularly limited, and synthesis may be performed by, for example, a known organic synthesis method, which is not repeated herein. Further, a commercially available product may also be directly used for the modified polyolefin (a), wherein specific examples of the commercially available product are described above and are not repeated herein.

Next, the modified polyolefin (a) is dissolved in a reaction solvent. The reaction solvent is preferably a non-polar solvent. Specific examples of the non-polar solvent include xylene, dichlorobenzene, paint solvent, and the like, but the invention is not limited thereto, and other non-polar solvents may be selected as needed. Further, the ratio of the modified polyolefin (a) to the non-polar solvent is not particularly limited as long as the modified polyolefin (a) may be dissolved and a subsequent reaction may be performed.

Then, the polyether amine (b1) is first added under a nitrogen atmosphere to react with the maleic anhydride group on the modified polyolefin (a) in a first reaction step. Next, the alkylamine (b2) is further added to react with the maleic anhydride group on the modified polyolefin (a) in a second reaction step.

The temperature of the first reaction step may be 120° C. to 170° C., and the time thereof may be 2 hours to 4 hours. The temperature of the second reaction step may be 120° C. to 170° C., and the time thereof may be 4 hours to 10 hours.

It is worth noting that the polyether amine (b1) and the alkylamine (b2) need to be reacted sequentially: after the polyether amine (b1) is completely reacted, the remaining maleic anhydride groups on the modified polyolefin (a) are completely reacted via the alkylamine (b2), the cyclization reaction of imide is catalyzed, and the excess alkylamine may be removed by distillation under reduced pressure or a small residual in the finished product.

After the above series of reactions, a solution containing a polyolefin derivative may be obtained. Lastly, the polyolefin derivative may be obtained by removing the solvent via distillation under reduced pressure.

More specifically, the polyolefin derivative includes a structural unit represented by formula (5) and a structural unit represented by formula (6). Next, the structural unit represented by formula (5) and the structural unit represented by formula (6) are described.

The structural unit represented by formula (5) is an imide structural unit formed by reacting the polyether amine (b1) and a maleic anhydride group on the modified polyolefin (a).

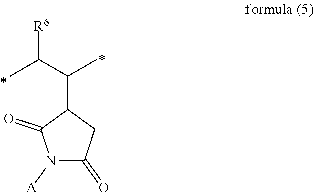

in formula (5),
R⁶ is a hydrogen atom or an alkyl group, preferably a hydrogen atom or a methyl group;
A is a monovalent organic group having an oxyalkylene group, preferably a monovalent organic group having an oxyethylene group or an oxypropylene group;
* represents a bonding position.

In formula (5), when R⁶ is a hydrogen atom, the polyolefin used as a precursor of the polyolefin derivative is polyethylene; and when R⁶ is a methyl group, the polyolefin used as a precursor of the polyolefin derivative is polypropylene.

In formula (5), the monovalent organic group having the oxyalkylene group is derived from the polyether amine (b1). The oxyalkylene group is, for example, an oxyethylene group or an oxypropylene group. The “oxyethylene group” is a group represented by (—CH₂CH₂—O—) and is also referred to as an ethyleneoxy group. The “oxypropylene group” is a group represented by (—CHCH₃CH₂—O—) and is also referred to as a propyleneoxy group.

In formula (5), the monovalent organic group having the alkyleneoxy group as A is, for example, a group represented by formula (5-1) or a group represented by formula (5-2), preferably a group represented by formula (5-1).

In formula (5), the monovalent organic group having the alkyleneoxy group as A may have a molecular weight of 1480 to 4985, preferably 1980 to 3985.

The group represented by formula (5-1) is derived from the compound represented by formula (1). Further, the group represented by formula (5-1) is a residue obtained by removing the amine group from the compound represented by formula (1).

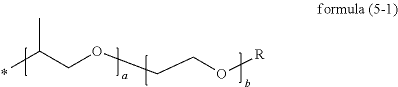

In formula (5-1), R is a C₁ to C₁₀ alkyl group, preferably a methyl group; a is an integer of 0 to 85; b is an integer of 0 to 112, a sum of a and b is an integer of 22 to 112, and * represents a bonding position.

The group represented by formula (5-2) is derived from the compound represented by formula (2). Further, the group represented by formula (5-2) is a residue obtained by removing the amine group from the compound represented by formula (2).

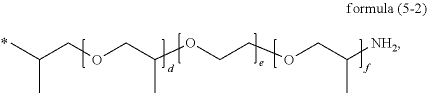

In formula (5-2), d and f are respectively an integer of 1 or more, a sum of d and f is an integer of 2 to 85, e is an integer of 0 to 112, and * represents a bonding position.

The total of the structural unit represented by formula (5) and the structural unit represented by formula (6) is 100 parts by mole, and the quantity of the structural unit represented by formula (5) is 60 parts by mole to 99 parts by mole. When the quantity of the structural unit represented by formula (5) is within the above range, the polyolefin derivative has good heat resistance and dispersibility, and thus has good applicability. When the quantity of the structural unit represented by formula (5) is less than 60 parts by mole, the dispersibility of the polyolefin derivative is poor. When the quantity of the structural unit represented by formula (5) is greater than 99 parts by mole, the heat resistance of the polyolefin derivative is poor.

It is to be noted that since the structural unit represented by formula (5) is an imide structural unit formed by reacting the polyether amine (b1) and a maleic anhydride group on the modified polyolefin (a), the ratio of the quantity of the structural unit represented by formula (5) to the total quantity of the structural unit represented by formula (5) and the structural unit represented by formula (6) is substantially the same as the ratio of the reacting amount of the polyether amine (b1) to the quantity of the maleic anhydride group of the modified polyolefin.

The structural unit represented by formula (6) is a structural unit formed by reacting the alkylamine (b2) and a maleic anhydride group on the modified polyolefin (a).

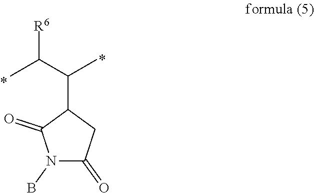

In formula (6), R⁷ is a hydrogen atom or an alkyl group, preferably a hydrogen atom or a methyl group;
B is a monovalent organic group, and the monovalent organic group is a monovalent organic group having an alkoxy group, an alkyl group, or a monovalent organic group having a nitrogen atom, preferably an alkyl group or a monovalent organic group having a nitrogen atom;
* represents a bonding position.

In formula (6), when R⁷ is a hydrogen atom, the polyolefin used as a precursor of the polyolefin derivative is polyethylene; and when R⁷ is a methyl group, the polyolefin used as a precursor of the polyolefin derivative is polypropylene.

In formula (6), the monovalent organic group is derived from the alkylamine (b2).

In formula (6), the monovalent organic group as B is, for example, a group represented by formula (6-1) or a group represented by formula (6-2), preferably a group represented by formula (6-1). When the polyolefin derivative includes the group represented by formula (6-1), the polyolefin derivative has better dispersibility.

The group represented by formula (6-1) is derived from the compound represented by formula (3). Further, the group represented by formula (6-1) is a residue obtained by removing the amine group from the compound represented by formula (3).

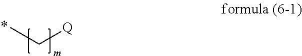

In formula (6-1),
m is an integer of 2 to 5, preferably an integer of 2 to 3;
Q is *—OR¹, *—NR²R³,

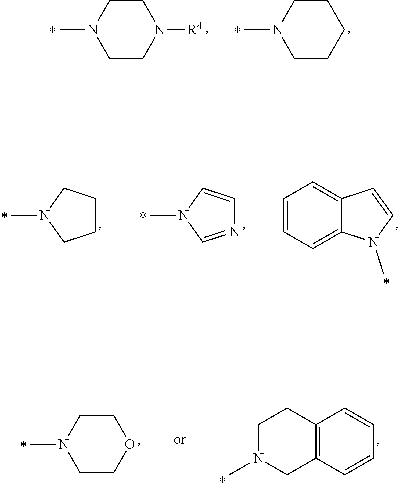

preferably *—NR²R³ or

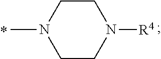

R¹, R², R³, and R⁴ are respectively hydrogen or a C₁ to C₆ alkyl group, R² and R³ are not hydrogen at the same time, and * represents a bonding position.

In an embodiment, when Q is *—NR²R³, R² and R³ are preferably a methyl group or an ethyl group, respectively.

In an embodiment, when Q is

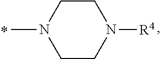

R⁴ is preferably hydrogen.

The group represented by formula (6-2) is derived from the compound represented by formula (4). Further, the group represented by formula (6-2) is a residue obtained by removing the amine group from the compound represented by formula (4).

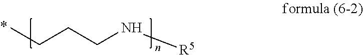

In formula (6-2), n is an integer of 0 to 3, preferably 0 or 1;
R⁵ is a C₈ to C₂₂ alkyl group, preferably a C₁₈ alkyl group.

In an embodiment, when n is 0, R⁵ is preferably a C₁₈ alkyl group.

In an embodiment, when n is 1, R⁵ is preferably a C₁₈ alkyl group.

The total of the structural unit represented by formula (5) and the structural unit represented by formula (6) is 100 parts by mole, and the quantity of the structural unit represented by formula (6) is 1 part by mole to 40 parts by mole. When the quantity of the structural unit represented by formula (6) is within the above range, the polyolefin derivative has good heat resistance and dispersibility, and thus has good applicability. When the quantity of the structural unit represented by formula (6) is greater than 40 parts by mole, the dispersibility of the polyolefin derivative is poor. When the quantity of the structural unit represented by formula (6) is less than 1 part by mole, the heat resistance of the polyolefin derivative is poor.

It is to be noted that since the structural unit represented by formula (6) is an imide structural unit formed by reacting the alkylamine (b2) and a maleic anhydride group on the modified polyolefin (a), the ratio of the quantity of the structural unit represented by formula (6) to the total quantity of the structural unit represented by formula (5) and the structural unit represented by formula (6) is substantially the same as the ratio of the reacting amount of the alkylamine (b2) to the quantity of the maleic anhydride group of the modified polyolefin.

It is to be noted that the polyolefin derivative may include other structural units in addition to the structural unit represented by formula (5) and the structural unit represented by formula (6). The other structural units are, for example, an amic acid structural unit. Here, the amic acid structural unit includes an amic acid structural unit formed by reacting the polyether amine (b1) and a maleic anhydride group on the modified polyolefin (a), but has not yet undergone a cyclization reaction; and an amic acid structural unit formed by reacting the alkylamine (b2) and a maleic anhydride group on the modified polyolefin (a), but has not yet undergone a cyclization reaction.

In an embodiment, in the polyolefin derivative, the monovalent organic group having the oxyalkylene group as A is a group represented by formula (5-1), and the monovalent organic group as B is a group represented by formula (6-1). When the polyolefin derivative includes the group represented by formula (5-1) and the group represented by formula (6-1), the polyolefin derivative has better dispersibility.

The application of the polyolefin derivative of the present embodiment is not particularly limited. For example, the polyolefin derivative of the present embodiment may be applied to the field of polypropylene modification, as well as the field of dispersion application of fillers or pigments.

Further, in the field of dispersion application of fillers, in order to improve the mechanical properties of polyolefin, fillers, glass fibers and the like are usually mixed in the polyolefin. However, since a general filler (polar filler) usually has a hydrophilic structure, the filler is difficult to be uniformly mixed with polyolefin. In this regard, since the polyolefin derivative of the present embodiment has an amphiphilic structure, the polyolefin derivative may be bonded to the filler via a hydrophilic functional group. Thereby, the composite material formed by combining the polyolefin derivative and the filler may be uniformly mixed with the polyolefin to achieve the effect of improving the mechanical properties of the polyolefin via the filler. Hereinafter, an example of a composite formed by combining a polyolefin derivative and a filler is described.

### <Composite Material>

A composite material according to the present embodiment includes the above polyolefin derivative and filler.

The filler includes a ceramic, a silicate layered material, aluminum oxide, silicon dioxide, calcium carbonate, wollastonite, barium sulfate, zinc sulfide, lithopone, cellulose, or a combination thereof. Specific examples of the silicate layered material include clay, talc, mica, kaolin, or a combination thereof. In addition, lithopone is a white pigment and is a mixture of zinc sulfide and barium sulfate as the components (CAS No. 1345-05-7).

Based on an amount of 100 parts by weight of the filler, the amount of the polyolefin derivative is 10 parts by weight to 200 parts by weight. When the amount of the polyolefin derivative is within the range of 10 parts by weight to 200 parts by weight, both the dispersibility and the mechanical properties of the polypropylene composite material may be satisfactory. When the amount of the polyolefin derivative is less than 10 parts by weight, the dispersibility is not satisfactory. When the amount of the polyolefin derivative is greater than 200 parts by weight, the mechanical properties are lowered due to the introduction of a large amount of the polyolefin derivative.

The preparation method of the composite material is not particularly limited. For example, the polyolefin derivative and the filler may be mixed in an extruder or a kneader; or the filler and the polyolefin derivative may be added to xylene for surface modification via a homogenizer or a bead mill at a suitable temperature, after which the xylene is removed to obtain a composite material.

Examples are provided below to more specifically describe the invention. Although the following experiments are described, the materials used and the amount and ratio of each thereof, as well as treatment details and treatment procedures . . . etc. may be suitably modified without exceeding the scope of the invention. Accordingly, restrictive interpretation should not be made to the invention based on the experiments described below.

### <Preparation of Polyolefin Derivative and Evaluation Results Thereof>

Examples 1 to 8 and Comparative examples 1 to 9 of the polyolefin derivative are described herein.

### Example 1

After 12.13 g of maleic anhydride-grafted polypropylene (PPgMA, containing 5.62 mmole of a maleic anhydride group, manufactured by Sanyo Chemical Industries. Ltd., product name: UMEX 1010, weight-average molecular weight: 30,000, amount of maleic anhydride group: 4.54 wt %) as modified polyolefin and 100 g of xylene as a reaction solvent were added to a 250 mL three-necked flask, a reflux tube was placed on the three-necked flask and the bottle mouth was sealed with a rubber stopper. Next, the apparatus was placed in an oil bath at a temperature of 160° C. while continuously introducing dry nitrogen, and heating under reflux was performed for 30 minutes to dissolve the maleic anhydride-grafted polypropylene. Then, 10.1 g of a polyether amine (containing 3.37 mmol of an amine group) (product name “Jeffamine M3085”, manufactured by Huntsman Chemical Co., Ltd., weight-average molecular weight: 3,000) was added, and the mixture was reacted for 2 hours. Next, 0.910 g of N-oleyl-1,3-diaminopropane, product name “Duomeen O”, 2.80 mmol) was added, and the mixture was reacted for 4 hours. Lastly, after the xylene was removed via a rotary decompression concentrator, 21.5 g of a polyolefin derivative was obtained.

### Examples 2 and 5 to 8, Comparative Examples 6 and 7

The preparation method of Examples 2, 5 to 8, and Comparative examples 6 and 7 was the same as that of Example 1 except that the type and amount of each component and the amount of the solvent were changed. The composition of each of the examples and the amount thereof are shown in Table 1.

### Example 3

After 12.13 g of maleic anhydride-grafted polypropylene (PPgMA, containing 5.62 mmole of a maleic anhydride group, manufactured by Sanyo Chemical Industries, Ltd., product name: UMEX 1010, weight-average molecular weight: 30,000, amount of maleic anhydride group: 4.54 wt %) as modified polyolefin and 60 g of xylene as a reaction solvent were added to a 250 mL three-necked flask, a reflux tube was placed on the three-necked flask and the bottle mouth was sealed with a rubber stopper. Next, the apparatus was placed in an oil bath at a temperature of 160° C. while continuously introducing dry nitrogen, and heating under reflux was performed for 30 minutes to dissolve the maleic anhydride-grafted polypropylene. Then, 15.2 g of a polyether amine (containing 5.07 mmol of an amine group) (product name “Jeffamine M3085”, manufactured by Huntsman Chemical Co., Ltd., weight-average molecular weight: 3000) was added, and the mixture was reacted for 2 hours. Next, 0.370 g of N-oleyl-1,3-diaminopropane, product name “Duomeen O”, 1.14 mmol) was added, and the mixture was reacted for 4 hours. Next, 0.33 g of 3-diethylaminopropylamine (DEX, 2.53 mmol) was further added, and the mixture was reacted for 4 hours. Lastly, after the xylene was removed by a rotary decompression concentrator, a polyolefin derivative was obtained.

### Example 4

The preparation method of Example 4 was the same as that of Example 3 except that 0.370 g of N-octadecylpropane-1,3-diamine was substituted with 0.300 g of octadecylamine to change the type and the amount of each composition and the amount of the solvent. The composition of each of the examples and the amount thereof are shown in Table 1.

### Comparative Example 1

Comparative example 1 is a control group in which the dispersibility was directly measured without the addition of any polymer.

### Comparative Example 2

In Comparative example 2, a modified polyolefin (PPgMA, containing 5.62 mmole of a maleic anhydride group, manufactured by Sanyo Chemical Industries, Ltd., product name: UMEX 1010, weight-average molecular weight: 30,000, amount of maleic anhydride group: 4.54 wt %) was directly used as a comparative example.

### Comparative Example 3

In Comparative example 3, “Jeffamine M2070” was directly used as a comparative example.

### Comparative Example 4

In Comparative example 4, “Jeffamine M3085” was directly used as a comparative example.

### Comparative Example 5

The preparation method of Comparative example 5 was the same as that of Example 1, except that the type and the amount of each composition and the amount of the solvent were changed, and the step of adding a polyether amine to perform the reaction was omitted. The composition of Comparative example 5 and the amount thereof are shown in Table 1.

### Comparative Examples 8 and 9

The preparation method of Comparative examples 8 and 9 was the same as that of Example 1, except that the type and the amount of each composition and the amount of the solvent were changed, and the step of adding an alkylamine to perform the reaction was omitted. The composition of Comparative examples 8 and 9 and the amount thereof are shown in Table 1.

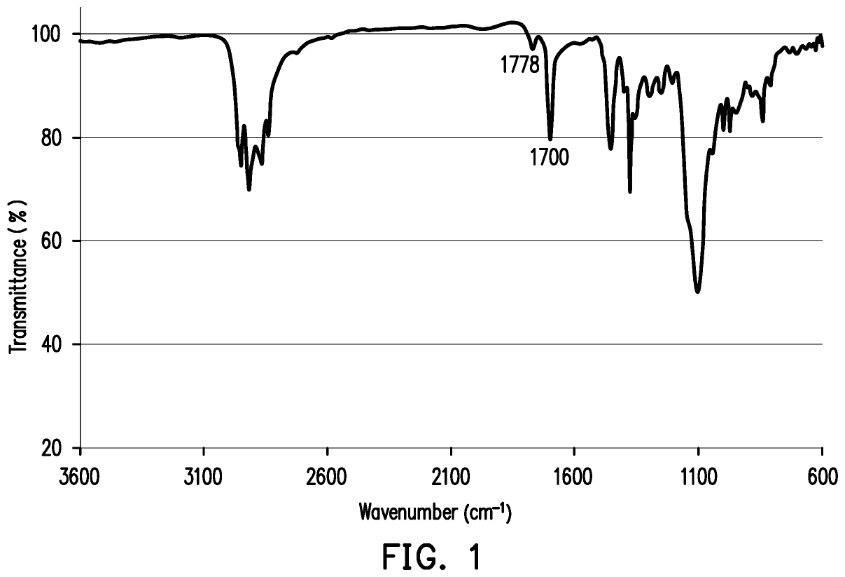

The IR spectrum of the polyolefin derivatives of Example 8 and Comparative example 8 was measured via Fourier transform infrared spectroscopy (FT-IR) (model “Spectrum 100”, manufactured by PerkinElmer Co., Ltd.) using zinc selenide (ZnSe). FIG. 1 is an IR spectrum of the polyolefin derivative of Example 8. Please refer to FIG. 1. FIG. 1 shows a signal representing imide at wavenumbers 1700 cm⁻¹ and 1778 cm⁻¹. This means that the maleic anhydride group on the PPgMA of Example 8 was completely reacted into imide.

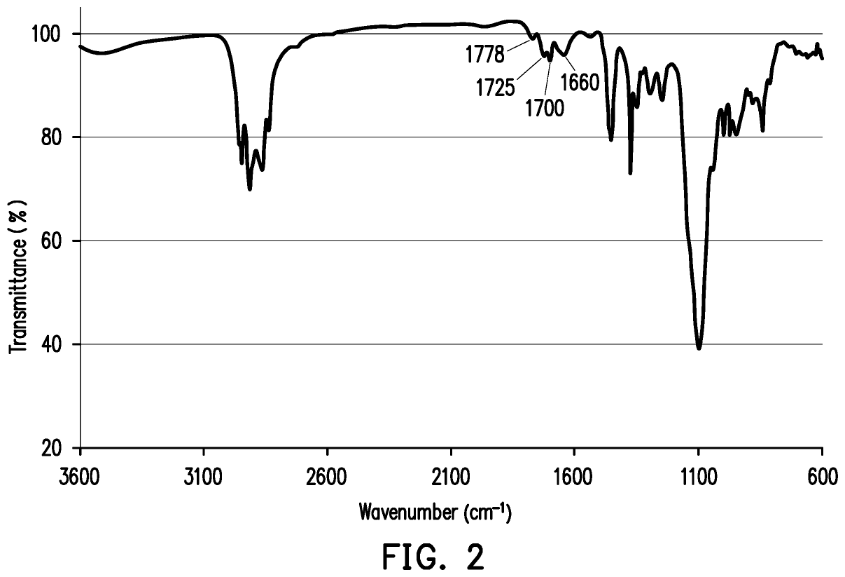

FIG. 2 is an IR spectrum of a polyolefin derivative of Comparative example 8. Please refer to FIG. 2. FIG. 2 shows a signal representing imide at wavenumbers 1700 cm⁻¹ and 1778 cm⁻¹, a signal representing carboxylic acid at wavenumber 1725 cm⁻¹, and a signal representing an amine group of an amide group at wavenumber 1660 cm⁻¹. This means in the reaction of Comparative example 8, an excess of M2070 was reacted with PPgMA to completely react the maleic anhydride group on PPgMA with the amine group on M2070, but was not completely react into imide.

### [Evaluation Methods]

### 1. Heat Resistance

The polymers of Examples 1 to 8 and Comparative examples 2 to 9 were subjected to thermogravimetric analysis using a thermogravimetric analyzer (Model “Q-500”, manufactured by TA Instrument Co., Ltd.) The analysis conditions were air atmosphere, 30° C. as starting temperature, and heating at a rate of 10° C./minute to 140° C. and keeping the temperature for 20 minutes. Next, heating was performed to 300° C. at a rate of 10° C./minute and the temperature was kept constant for 20 minutes. The weight loss percentage was calculated by formula (I). The lower the percentage of weight loss, the better the heat resistance of the polymer. Conversely, a higher percentage of weight loss indicates a worse heat resistance of the polymer.

$$Weight loss percentage ( \% ) = \frac{{M}_{{140}^{°} C .} - {M}_{{300}^{°} C .}}{{M}_{loading}} \times 100 \% \qquad formula ( I )$$

In formula (I), M_{140° C.} is the weight at which the sample starts to heat up at 140° C., M_{300° C.} is the weight of the sample kept at 300° C. for 20 minutes, and M_{loading} is the original weight of the sample measured by a scale.

### 2. Dispersibility

### 2.1 Viscosity

The polymers of Examples 1 to 8 and Comparative examples 1 to 9 were dispersed in xylene, and then the viscosity of the solution was measured by using a viscometer (model “Viscometer DV-II+Pro”, manufactured by Brookfield Corporation) at 25° C. and 15 RPM.

### 2.2 Filterability

1.00 g of organic modified clay (product name “Tixogel VP”, manufactured by BYK Co., Germany), 1.00 g of the polymers of Examples 1 to 8 and Comparative examples 1 to 9, 60.00 g of 0.3 mm zirconium balls, and 29.00 g of xylene were added to a plastic tube having a volume of 50.00 ml and a diameter of 2.5 cm. After dispersing for 2 hours with a Red Devil disperser (model “1400-OH”, manufactured by Red Devil, USA), the dispersion was removed. Next, filtering was performed using a 2800 mesh and a metal film having a filtering area of 3.8 cm², and the weight of the slurry that could pass through when blocked was recorded.

The evaluation criteria of filterability are as shown below:
ND: the solution formed a colloid and filterability may not be measured;
Poor: weight of the slurry that may pass through≤3 g;
Acceptable: 3 g<weight of the slurry that may pass through≤9 g;
Good: 9 g<weight of the slurry that may pass through≤18 g;
Very good: 18 g<weight of the slurry that may pass through.

TABLE 1

| | Modified polyolefin (a) | | | | Amine compound (b) | | | | |
|---|---|---|---|---|---|---|---|---|---|
| | | | Amount of | Molar | Polyether amine (b1) | | | | |
| | | | maleic | ratio of | | | Amine | Molar | |
| | | | anhydride | maleic | | | group | ratio of | |
| | | Weight | group | anhydride | | Weight | Amount | polyether | Alkylamine (b2) |
| | Type | (g) | (mmol) | group | Type | (g) | (mmol) | amine | Type |
| Example 1 | PPgMA | 12.13 | 5.62 | 1.00 | M3085 | 10.1 | 3.37 | 0.60 | DuO |
| Example 2 | PPgMA | 12.13 | 5.62 | 1.00 | M3085 | 12.6 | 4.20 | 0.75 | DuO |
| Example 3 | PPgMA | 12.13 | 5.62 | 1.00 | M3085 | 15.2 | 5.07 | 0.90 | DuO |
| | | | | | | | | | DEX |
| Example 4 | PPgMA | 12.13 | 5.62 | 1.00 | M3085 | 15.2 | 5.07 | 0.60 | Octadecylamine |
| | | | | | | | | | DEX |
| Example 5 | PPgMA | 12.13 | 5.62 | 1.00 | M3085 | 12.6 | 4.20 | 0.75 | DEX |
| Example 6 | PPgMA | 12.13 | 5.62 | 1.00 | M3085 | 16.5 | 5.50 | 0.98 | DEX |
| Example 7 | PPgMA | 12.13 | 5.62 | 1.00 | M3085 | 15.2 | 5.07 | 0.90 | N-AEP |
| | | | | | | | | | DEX |
| Example 8 | PPgMA | 12.13 | 5.62 | 1.00 | M2070 | 6.8 | 3.40 | 0.60 | DEX |
| Comparative | None | — | — | — | — | — | — | — | — |
| example 1 | | | | | | | | | |
| Comparative | PPgMA | 12.13 | 5.62 | 1.00 | — | — | — | — | — |
| example 2 | | | | | | | | | |
| Comparative | — | — | — | — | M2070 | — | — | — | — |
| example 3 | | | | | | | | | |
| Comparative | — | — | — | — | M3085 | — | — | — | — |
| example 4 | | | | | | | | | |
| Comparative | PPgMA | 12.13 | 5.62 | 1.00 | — | — | — | — | DEX |
| example 5 | | | | | | | | | |
| Comparative | PPgMA | 12.13 | 5.62 | 1.00 | M2070 | 5.6 | 2.80 | 0.50 | DMX |
| example 6 | | | | | | | | | |
| Comparative | PPgMA | 12.13 | 5.62 | 1.00 | M2070 | 5.6 | 2.80 | 0.50 | DEX |
| example 7 | | | | | | | | | |
| Comparative | PPgMA | 12.13 | 5.62 | 1.00 | M2070 | 11.8 | 5.90 | 1.00 | — |
| example 8 | | | | | | | | | |
| Comparative | PPgMA | 12.13 | 5.62 | 1.00 | M3085 | 17.7 | 5.90 | 1.00 | — |
| example 9 | | | | | | | | | |

| | | | | | Evaluation results | | |
|---|---|---|---|---|---|---|---|
| | | | | | Heat | | |
| | Amine compound (b) | | | | resistance | | |
| | Alkylamine (b2) | | | Solvent | Weight | | |
| | | Amount of | Molar | Xylene | loss | | |
| | Weight | alkylamine | ratio of | Weight | percentage | Dispersibility | |
| | (g) | (mmol) | alkylamine | (g) | (%) | Viscosity | Filterability |
| Example 1 | 0.910 | 2.80 | 0.40 | 100 | 24 | 168 | Good |
| Example 2 | 0.630 | 1.94 | 0.25 | 100 | 34 | 142 | Very good |
| Example 3 | 0.370 | 1.14 | 0.10 | 60 | 19 | 143 | Very good |
| | 0.330 | 2.53 | | | | | |
| Example 4 | 0.300 | 1.11 | 0.40 | 60 | 40 | 151 | Good |
| | 0.330 | 2.53 | | | | | |
| Example 5 | 0.550 | 4.22 | 0.25 | 60 | 42 | 145 | Very good |
| Example 6 | 0.420 | 3.23 | 0.02 | 100 | 42 | 148 | Very good |
| Example 7 | 0.110 | 0.85 | 0.10 | 160 | 28 | 155 | Good |
| | 0.330 | 2.53 | | | | | |
| Example 8 | 0.705 | 5.41 | 0.40 | 100 | 17 | 104 | Good |
| Comparative | — | — | — | — | — | Gelation | ND |
| example 1 | | | | | | | |
| Comparative | — | — | — | — | 48 | Gelation | ND |
| example 2 | | | | | | | |
| Comparative | — | — | — | — | 92 | — | — |
| example 3 | | | | | | | |
| Comparative | — | — | — | — | 91 | — | — |
| example 4 | | | | | | | |
| Comparative | 0.770 | 5.91 | 1.00 | 50 | 23 | Gelation | ND |
| example 5 | | | | | | | |
| Comparative | 0.280 | 2.78 | 0.50 | 50 | 29 | 190 | Poor |
| example 6 | | | | | | | |
| Comparative | 0.365 | 2.80 | 0.50 | 50 | 19 | 148 | Poor |
| example 7 | | | | | | | |
| Comparative | — | — | — | 50 | 55 | 162 | Very good |
| example 8 | | | | | | | |
| Comparative | — | — | — | 70 | 73 | 140 | Good |
| example 9 | | | | | | | |

It is to be noted that in the steps of synthesizing the polyolefin derivatives of Examples 1 to 8, the maleic anhydride group on the modified polyolefin and the amine group on the polyether amine were first controlled to be completely reacted, and then excess alkylamine was reacted with the remaining maleic anhydride groups on the modified polyolefin.

In Table 1, “amount of maleic anhydride group” is the amount of the maleic anhydride group on the modified polyolefin. The “amount of amine group” is the amount of the amine group on the polyether amine, wherein the single molecules of M3085 and M2070 both only contained one amine group and the maleic anhydride group on the modified polyolefin and the amine group on the polyether amine were completely reacted, and therefore the amount of the amine group on the polyether amine was substantially the same as the amount of the polyether amine in the reaction solution. The “amount of alkylamine” is the amount of the alkylamine (excess reagent) in the reaction solution.

The “molar ratio” in Table 1 is the molar ratio between a maleic anhydride group contained in the modified polyolefin, a polyether amine actually reacted with the maleic anhydride group, and an alkylamine actually reacted with the maleic anhydride group. It is worth noting that the above molar ratio is also equivalent to the molar ratio between the maleic anhydride group, the residue from the reaction with the maleic anhydride group and derived from the polyether amine (i.e., residue after the amine group is removed from the polyether amine), and the residue from the reaction with the maleic anhydride group and derived from the alkylamine (i.e., residue after the amine group is removed from the alkylamine) in the polymer as the final product.

In addition, in Table 1, the abbreviations are as follows:
PPgMA: maleic anhydride-grafted polypropylene (PPgMA, manufactured by Sanyo Chemical Industries, Ltd., product name UMEX 1010, weight-average molecular weight 30,000, amount of maleic anhydride group: 4.54 wt %).
M3085: Jeffamine M3085 (manufactured by Huntsman Chemical Industry Co., Ltd., weight-average molecular weight: 3000).
M2070: Jeffamine M2070 (manufactured by Huntsman Chemical Industry Co., Ltd., weight-average molecular weight: 2000).
DuO: N-Oleyl-1,3-diaminopropane (product name: Duomeen O, manufactured by Akzo Nobel).
DMX: 3-dimethylaminopropylamine.
DEX: 3-diethylaminopropylamine.
N-AEP: aminoethylpiperazine.

### [Evaluation Results]

According to Table 1, when the molar ratio of the maleic anhydride group contained in the modified polyolefin was 1.00, the molar ratio of the alkylamine was in the range of 0.01 to 0.40, and when the molar ratio of the polyether amine was in the range of 0.60 to 0.99 (Examples 1 to 8), the polyolefin derivative had good heat resistance and dispersibility.

Without the addition of any polymer (Comparative example 1), the solution viscosity thereof was extremely high and the solution formed a colloid, and the organically modified clay and xylene encased the zirconium balls and the viscosity thereof could not be measured.

The modified polyolefin (PPgMA) (Comparative example 2) had poor heat resistance and poor dispersibility.

The polyether amine (Comparative examples 3 and 4) had poor heat resistance.

In the case that only the alkylamine was used to react with the modified polyolefin (Comparative example 5), although the polyolefin derivative had good heat resistance, the dispersibility thereof was poor.

When the molar ratio of the maleic anhydride group contained in the modified polyolefin was 1.00 and the molar ratio of the polyether amine was less than 0.60 (Examples 6 and 7), the dispersibility of the polyolefin derivative was poor. Therefore, when the ratio of the polyether amine was not sufficiently high in the reactant, the dispersibility of the polyolefin derivative was poor.

When only the polyether amine was used to react with the modified polyolefin (Comparative examples 8 and 9), the heat resistance of the polyolefin derivative was poor. Further, in the case that the polyether amine was excessively equivalent with respect to the modified polyolefin, the reaction of the modified polyolefin and the polyether amine was still incomplete, and the synthesized polyolefin derivative may have insufficient heat resistance. Further, when a polyether amine having a greater molecular weight was used, the overall oxyalkylene group (ether group) in the polyolefin derivative was increased, so that the polyolefin derivative of Comparative example 9 (M3085, molecular weight of the polyether amine was 3000) had worse heat resistance than that of the polyolefin derivative of Comparative example 8 (M2070, molecular weight of the polyether amine was 2000).

### <Preparation and Evaluation Results of Composite Material>

Next, Examples 9 to 15 in which the polyolefin derivative of Example 1 was used to form a composite material and Comparative examples 10 to 16 without using the polyolefin derivative are described.

### Examples 9 to 14

According to Table 2, 1.5 g of the filler, 1.0 g of the polyolefin derivative of Example 1, 60.0 g of 0.3 mm zirconium balls, and 29.0 g of xylene were placed in a plastic tube having a volume of 50 ml and a diameter of 2.5 cm. After dispersing for 2 hours with a Red Devil disperser (model “1400-OH”, manufactured by Red Devil, USA) and leaving to stand for half an hour, the dispersion was obtained.

### Examples 15

According to Table 2, a dispersion was prepared in the same manner as in Examples 9 to 14 except that 0.22 g of cellulose was used as a filler.

### Comparative Examples 10 to 15

According to Table 2, 1.5 g of the filler, 60.0 g of 0.3 mm zirconium balls, and 29.0 g of xylene were placed in a plastic tube having a volume of 50 ml and a diameter of 2.5 cm. After dispersing for 2 hours with a Red Devil disperser (model “1400-OH”, manufactured by Red Devil, USA) and leaving to stand for half an hour, the occurrence of solid liquid stratification phenomenon was observed. When solid liquid stratification phenomenon was not occurred, the dispersion was obtained.

### Comparative Examples 16

According to Table 2, a sample was prepared in the same manner as in Comparative examples 10 to 15 except that 0.22 g of cellulose was used as a filler.

TABLE 2

| | | | | Solid | Dis- |
|---|---|---|---|---|---|
| | Filler | | Polyolefin | content of | persion |
| | | Weight | derivative | dispersion | viscosity |
| | Type | (wt %) | (wt %) | (wt %) | (cp) |
| Example 9 | Organic | 4.8 | 3.2 | 8.0 | 131 |
| | modified clay | | | | |
| Example 10 | Sodium-based | 4.8 | 3.2 | 7.1 | 28 |
| | soil | | | | |
| Example 11 | Hydrophilic | 4.8 | 3.2 | 8.0 | 24 |
| | silicon | | | | |
| | dioxide | | | | |
| Example 12 | Hydrophilic | 4.8 | 3.2 | 7.7 | 28 |
| | aluminum oxide | | | | |
| Example 13 | Calcium | 4.8 | 3.2 | 7.9 | 21 |
| | carbonate | | | | |
| Example 14 | Talc | 4.8 | 3.2 | 8.0 | 38 |
| Example 15 | Cellulose | 0.7 | 3.2 | 3.5 | 1.1 |
| Comparative | Organic | 4.9 | — | ND | Gela- |
| example 10 | modified clay | | | | tion |
| Comparative | Sodium- | 4.9 | — | Solid liquid | ND |
| example 11 | based soil | | | stratification | |
| Comparative | Hydrophilic | 4.9 | — | Solid liquid | ND |
| example 12 | silicon | | | stratification | |
| | dioxide | | | | |
| Comparative | Hydrophilic | 4.9 | — | Solid liquid | ND |
| example 13 | aluminum | | | stratification | |
| | oxide | | | | |
| Comparative | Calcium | 4.9 | — | Solid liquid | ND |
| example 14 | carbonate | | | stratification | |
| Comparative | Talc | 4.9 | — | Solid liquid | ND |
| example 15 | | | | stratification | |
| Comparative | Cellulose | 0.7 | — | Solid liquid | ND |
| example 16 | | | | stratification | |

In Examples 9 to 15 of Table 2, the weight percentage of the filler is the percentage of the weight of the filler relative to the total weight of the dispersion composed of the filler, the polyolefin derivative, and xylene. The weight percentage of the polyolefin derivative is the percentage of the weight of the polyolefin derivative relative to the total weight of the dispersion composed of the filler, the polyolefin derivative, and xylene. Moreover, in Comparative examples 10 to 15 of Table 2, the weight percentage of the filler is the percentage of the weight of the filler relative to the total weight of the sample composed of the filler, and xylene.

In addition, in Table 2, the product names and manufacturers of each filler are shown in Table 3 below:

TABLE 3

| Filler | Manufacturer | Product name |
|---|---|---|
| Organic modified | BYK Co. | Tixogel VP |
| clay | | |
| Sodium-based soil | BYK Co. | Cloisite Na+ |
| Hydrophilic silicon | Evonik Industries | Aerosil OX-50 |
| dioxide | | |
| Hydrophilic | Evonik Industries | Aeroxide Alu C |
| aluminum oxide | | |
| Calcium carbonate | Formosa Plastics Corporation | FCC-300 |
| Talc | Mondo Minerals | Plustalc H10 |
| Cellulose | Henry Chemical Co. | CNF-4 Solid |
| | | Refine material |

### [Evaluation Results]

In Table 2, the dispersion solid content and the dispersion viscosity were used to evaluate the amount of the composite materials (mixture of filler and polyolefin derivative) of Examples 9 to 15 and the fillers of Comparative examples 10 to 16 dispersed in a low-polar solvent such as xylene.

Regarding the dispersion solid content, when the solid content of the dispersion was lower, it indicates that the surface modification of the filler by the polyolefin derivative was good, and thus the dispersibility of the composite in xylene was good. Further, in Table 2, when the solid content of the dispersion was “ND”, it indicates that the solution formed a colloid and the solid content of the dispersion may not be measured (that is, poor dispersibility in xylene). In addition, when the solid content of the dispersion was “solid liquid stratification”, it indicates that the filler alone may not be uniformly mixed with a non-polar substance such as xylene (that is, poor dispersibility in xylene).

Regarding the viscosity of the dispersion, when the viscosity of the dispersion was lower, the polyolefin derivative had a good surface modification effect on the filler, and therefore the dispersibility of the composite material in xylene was better. Further, in Table 2, when the viscosity of the dispersion was “Gelation”, it indicates that the solution formed a colloid (that is, poor dispersibility in xylene). In addition, when the viscosity of the dispersion was “ND”, a solid liquid stratification phenomenon was occurred and the viscosity of the dispersion may not be measured (that is, the filler alone may not be uniformly mixed with a non-polar substance such as xylene).

It should be mentioned that, since xylene was a low-polar solvent, that state in which the composite material was dispersed in the non-polar polyolefin may be inferred from the dispersibility of the composite material or the filler in xylene. Furthermore, when the composite material had good dispersibility in xylene, it may be inferred that the composite material also had good dispersibility in the polyolefin and was suitable for the field of dispersion application of the filler.

According to Table 2, when only the filler (Comparative examples 10 to 16) was dispersed in xylene, it was found that the solution formed a colloid, the viscosity was extremely high (Comparative example 10), and the viscosity became high, or the phenomenon of solid liquid stratification was directly produced and uniform dispersion in xylene could not occur (Comparative examples 11 to 16). It is inferred that the filler alone may not be uniformly mixed with a non-polar substance such as xylene or polyolefin.

In contrast, when the filler was mixed with the polyolefin derivative (Examples 9 to 15) and dispersed in xylene, the viscosity of the dispersion may be significantly lowered. Further, the dispersions of Examples 9 to 15 also had a certain dispersion solid content. Therefore, the polyolefin derivative may greatly improve the dispersibility of the filler in the non-polar substance. Further, it may be inferred that the composite material formed by combining the polyolefin derivative and the filler may be uniformly mixed with a non-polar substance such as polyolefin to achieve the effect of improving the mechanical properties of the polyolefin via the filler.

Based on the above, the polyolefin derivative of the invention has an amphiphilic structure and thus has good applicability. In addition, in the polyolefin derivative of the invention, a polyolefin grafted with maleic anhydride is reacted with a polyether amine and an alkylamine to prepare a functional group for which a main chain is a polyolefin and a side chain contains a polyether amine and an alkylamine. Therefore, the polyolefin derivative not only has an amphiphilic structure, but also allows the maleic anhydride group and the ring-opened carboxylic acid to be completely reacted, thus contributing to the improvement of the heat resistance of the polyolefin derivative. Further, the polyolefin derivative of the invention is obtained by reacting a polyolefin grafted with maleic anhydride and an amine compound containing a polyether amine and a specific ratio of an alkylamine, such that the polyolefin derivative has good heat resistance and dispersibility. Moreover, the composite material of the invention includes the polyolefin derivative and a filler, and therefore good dispersibility is achieved in a non-polar substance, such that uniform mixing with a polyolefin may be achieved to improve the mechanical properties of the polyolefin via good dispersion effect of the filler.

What is claimed is:

1. A polyolefin derivative formed by reacting a modified polyolefin and an amine compound,
wherein the modified polyolefin is formed by grafting a maleic anhydride onto a polyolefin,
the amine compound comprises a polyether amine and an alkylamine,
based on 100 parts by mole of a maleic anhydride group in the modified polyolefin, a reacting amount of the alkylamine is 1 part by mole to 40 parts by mole.

2. The polyolefin derivative according to claim 1, wherein based on 100 parts by mole of the maleic anhydride group in the modified polyolefin, a reacting amount of the polyether amine is 60 parts by mole to 99 parts by mole.

3. The polyolefin derivative according to claim 1, wherein a weight-average molecular weight of the polyether amine is 1500 to 5000.

4. The polyolefin derivative according to claim 1, wherein the polyether amine comprises at least one of a compound represented by formula (1) and a compound represented by formula (2), 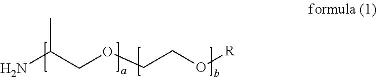
in formula (1), R is a C₁ to C₁₀ alkyl group, a is an integer of 0 to 85, b is an integer of 0 to 112, and a sum of a and b is an integer of 22 to 112, 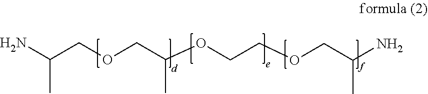
in formula (2), d and f are respectively an integer of 1 or more, a sum of d and f is an integer of 2 to 85, and e is an integer of 0 to 112.

5. The polyolefin derivative according to claim 1, wherein the alkylamine comprises at least one of a compound represented by formula (3) and a compound represented by formula (4), 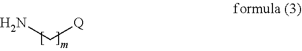
in formula (3), m is an integer of 2 to 5, and Q is *—OR¹, *—NR²R³, 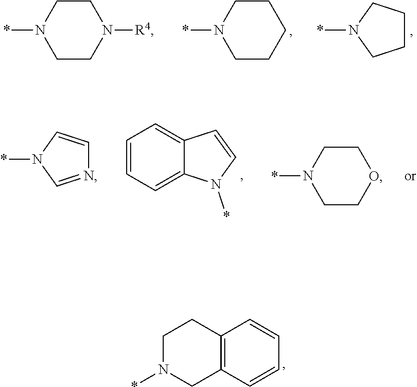
wherein R¹, R², R³, and R⁴ are respectively hydrogen or a C₁ to C₆ alkyl group, R² and R³ are not hydrogen at the same time, and * represents a bonding position, 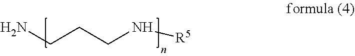
in formula (4), n is an integer of 0 to 3, and R⁵ is a C₈ to C₂₂ alkyl group.

6. A polyolefin derivative, comprising a structural unit represented by formula (5) and a structural unit represented by formula (6), 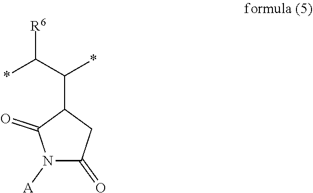
in formula (5), R⁶ is a hydrogen atom or an alkyl group, A is a monovalent organic group having an oxyalkylene group, and * represents a bonding position, 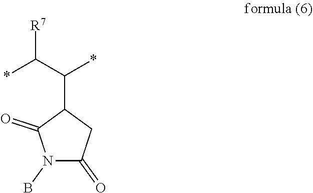
in formula (6), R⁷ is a hydrogen atom or an alkyl group, B is a monovalent organic group, the monovalent organic group is a monovalent organic group having an alkoxy group, an alkyl group, or a monovalent organic group having a nitrogen atom, and * represents a bonding position.

7. The polyolefin derivative according to claim 6, wherein based on a total of 100 parts by mole of the structural unit represented by formula (5) and the structural unit represented by formula (6), a quantity of the structural unit represented by formula (6) is 1 part by mole to 40 parts by mole.

8. The polyolefin derivative according to claim 6, wherein based on a total of 100 parts by mole of the structural unit represented by formula (5) and the structural unit represented by formula (6), a quantity of the structural unit represented by formula (5) is 60 parts by mole to 99 parts by mole.

9. The polyolefin derivative according to claim 6, wherein a molecular weight of the monovalent organic group having the oxyalkylene group as A is 1480 to 4985.

10. The polyolefin derivative according to claim 6, wherein the monovalent organic group having the oxyalkylene group as A is a group represented by formula (5-1) or a group represented by formula (5-2), 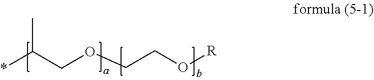
in formula (5-1), R is a C₁ to C₁₀ alkyl group, a is an integer of 0 to 85, b is an integer of 0 to 112, a sum of a and b is an integer of 22 to 112, and * represents a bonding position, 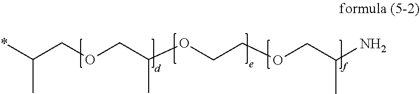
in formula (5-2), d and f are respectively an integer of 1 or more, a sum of d and f is an integer of 2 to 85, e is an integer of 0 to 112, and * represents a bonding position.

11. The polyolefin derivative according to claim 6, wherein the monovalent organic group as B is a group represented by formula (6-1) or a group represented by formula (6-2), 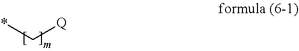
in formula (6-1), m is an integer of 2 to 5, and Q is *—OR¹, *—NR²R³, 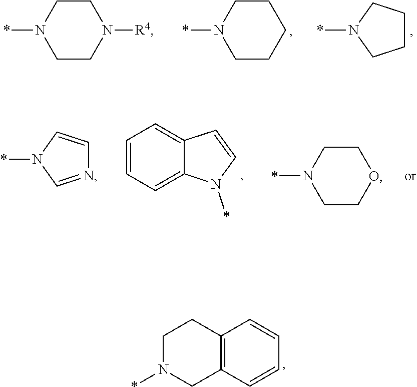
wherein R¹, R², R³, and R⁴ are respectively hydrogen or a C₁ to C₆ alkyl group, R² and R³ are not hydrogen at the same time, and * represents a bonding position, 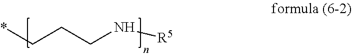
in formula (6-2), n is an integer of 0 to 3, and R⁵ is a C₈ to C₂₂ alkyl group.

12. The polyolefin derivative according to claim 6, wherein the monovalent organic group having the oxyalkylene group as A is a group represented by formula (5-1) and the monovalent organic group as B is a group represented by formula (6-1), 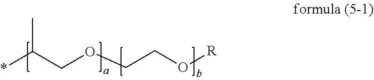
in formula (5-1), R is a C₁ to C₁₀ alkyl group, a is an integer of 0 to 85, b is an integer of 0 to 112, a sum of a and b is an integer of 22 to 112, and * represents a bonding position, 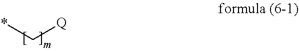
in formula (6-1), m is an integer of 2 to 5, and Q is *—OR¹, *—NR²R³, 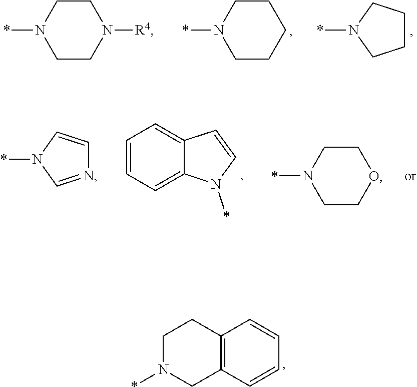
wherein R¹, R², R³, and R⁴ are respectively hydrogen or a C₁ to C₆ alkyl group, R² and R³ are not hydrogen at the same time, and * represents a bonding position.

13. The polyolefin derivative according to claim 6, wherein the polyolefin derivative is a derivative derived from a polyolefin, and the polyolefin comprises polyethylene, polypropylene, or a combination thereof.

14. A composite material, comprising the polyolefin derivative according to claim 1 and a filler.

15. The composite material according to claim 14, wherein based on an amount of 100 parts by weight of the filler, an amount of the polyolefin derivative is 10 parts by weight to 200 parts by weight.

16. The composite material according to claim 14, wherein the filler comprises a ceramic, a silicate layered material, aluminum oxide, silicon dioxide, calcium carbonate, wollastonite, barium sulfate, zinc sulfide, lithopone, cellulose, or a combination thereof.

17. A composite material, comprising the polyolefin derivative according to claim 6 and a filler.

18. The composite material according to claim 17, wherein based on an amount of 100 parts by weight of the filler, an amount of the polyolefin derivative is 10 parts by weight to 200 parts by weight.

19. The composite material according to claim 17, wherein the filler comprises a ceramic, a silicate layered material, aluminum oxide, silicon dioxide, calcium carbonate, wollastonite, barium sulfate, zinc sulfide, lithopone, cellulose, or a combination thereof.
